(19) United States
(12) Patent Application Publication
(10) Pub. No.: US 2025/0320147 A1
(43) Pub. Date: Oct. 16, 2025

(54) Mechanical Sludge Thickener System and Method Thereof

(71) Applicant: Adalberto Mercado Alvarado, Bayamon, PR (US)

(72) Inventor: Adalberto Mercado Alvarado, Bayamon, PR (US)

(21) Appl. No.: 19/097,607

(22) Filed: Apr. 1, 2025

Related U.S. Application Data
(63) Continuation-in-part of application No. 17/577,224, filed on Jan. 17, 2022, now Pat. No. 12,383,850.

(51) Int. Cl. C02F 11/125; B01D 29/23; B01D 29/90; B01D 35/30; B01D 39/10

(52) U.S. Cl. CPC C02F 11/125; B01D 29/23; B01D 29/90; B01D 35/30; B01D 39/10

(57) ABSTRACT

A mechanical sludge thickener system and method for efficiently separating liquid from sludge to produce thickened sludge and filtered liquid. The system comprises a first hollow chamber, an interconnecting chamber, a second hollow chamber, an actuator, a supporting base, an auger, a filter cup, a reactor, an inlet, and an outlet.

### CROSS-REFERENCE TO RELATED APPLICATION

This application is a continuation-in-part of, and claims the benefit of priority to, U.S. patent application Ser. No. 17/577,224, entitled “Automatic Self-Cleaning Filter Driven by Submersible Actuator”, and filed on Jan. 17, 2022, the contents of which are hereby incorporated by reference.

### STATEMENT REGARDING FEDERALLY SPONSORED RESEARCH AND DEVELOPMENT

N/A

### BACKGROUND OF THE INVENTION

### Field of the Invention

The subject disclosure relates to a mechanical sludge thickener system that is driven by a submersible actuator.

### Discussion of the Background

In wastewater treatment, sludge management is a critical process that involves reducing the volume of sludge by removing excess water. This is achieved through thickening and dewatering techniques, which serve to consolidate the sludge by increasing the concentration of suspended solids.

Thickening processes primarily remove a portion of the free water in sludge, allowing solid particles to settle and form a concentrated sludge stream while a supernatant, or diluted liquid stream, is withdrawn. Thickened sludge retains its liquid, free-flowing characteristics, making it suitable for pumping and further processing. Typically, thickening increases the dry solids (DS) content from approximately 2% to 4-6%.

Dewatering, in contrast, removes a significantly higher proportion of free water, yielding a sludge product known as a “cake.” This cake has minimal fluidity and requires alternative means of transport, such as conveyor belts or mechanical handling equipment. Dewatering results in a more solidified product compared to thickening, making it suitable for disposal or further processing. Various thickening techniques are employed in wastewater treatment plants, including:
(a) Gravity Thickening: Relies on the natural settling of sludge particles in a vessel, forming a thickened sludge at the base while the supernatant is drawn off;
(b) Centrifugal Thickening: Utilizes centrifugal force in a rotating container to separate thickened solids from a clarified centrate stream.
(c) Dissolved Air Flotation (DAF) Thickening: Uses buoyant air bubbles to encourage suspended particles to float to the surface for removal by skimming.
(d) Gravity Belt and Rotary Drum Thickening: Employs permeable mediums to drain liquid under gravity, leaving behind thickened sludge.

These thickening methods are energy-efficient and widely used to prepare sludge for subsequent anaerobic digestion or further processing. The efficiency of thickening and dewatering operations significantly impacts the overall performance and cost-effectiveness of wastewater treatment facilities.

The present disclosure introduces a mechanical sludge thickener utilizing a submersible actuator, which enhances the thickening process by optimizing sludge consolidation while maintaining operational efficiency. This technology aims to improve sludge handling, reduce treatment costs, and ensure consistent sludge quality for further processing or disposal.

### SUMMARY OF THE INVENTION

The subject disclosure relates to a mechanical sludge thickener system, comprising a first hollow chamber, an interconnecting chamber, a second hollow chamber, an actuator, a supporting base, an auger, a filter cup, a reactor, an inlet, and an outlet. The inlet comprises a plate having a central anchor point for the auger, an opening for receiving liquid sludge, and a flange. The first hollow chamber comprises: a first hollow tube having a first end and a second end opposite each other, one or more walls positioned between the first end and the second end of the first hollow chamber, and an interior space adapted to house and enclose the filter cup; and an annular space within the first hollow tube, located between the filter cup and the one or more walls of the first hollow chamber. The filter cup comprises: a hollow longitudinal structure having a first end and a second end opposite each other, one or more walls positioned between the first end and the second of the filter cup, an interior space enclosed by the walls of the filter cup, and a filter mesh surrounding and conforming to the one or more walls within the interior space of the filter cup; and one or more openings along the one or more walls of the filter cup that, within the interior space of the filter cup, are covered by the filter mesh; wherein the filter mesh is configured to separate liquid from the liquid sludge, producing a filtered liquid and a thickened sludge.

The auger, in turn, comprises: a helical screw having a first end and a second end opposite each other; wherein the first end of the auger includes a ball bearing that is adapted to couple with the anchor point of the inlet; and wherein the second end of the auger includes a coupling unit. The interconnecting chamber comprises: a hollow casing having a first end and a second end opposite each other, one or more walls positioned between the first end and the second end, an interior space adapted to house and enclose the reactor, and a discharge outlet on one of the walls of the interconnecting chamber for release of the thickened sludge. The reactor comprises: a first end and a second end opposite each other; a hollow conical cylinder, located between the first end and the second end, that includes one or more tapered walls and a truncated vertex that forms a flat surface; one or more internal channels connecting the first end of the reactor to the second end of the reactor, and surrounding the hollow conical cylinder; wherein each of the internal channels has an access point on the first end of the reactor and an exit point on the second end of the reactor; wherein each of the one or more internal channels is adapted to receive the filtered liquid, via the access point, from the annular space in the first hollow chamber and transfer the filtered liquid, via the exit point, to the second hollow chamber; wherein the flat surface includes an opening that provides access to the discharge outlet; wherein the first end of the reactor includes a central opening adapted to provide access to the interior of the hollow conical cylinder of the reactor; wherein the second end of the reactor includes an opening adapted to provide access to the interior of the hollow conical cylinder of the reactor.

Moreover, the second hollow chamber comprises: a second hollow tube having a first end and a second end opposite each other, one or more walls positioned between the first end and the second end of the second hollow chamber, and an interior space adapted to house the actuator and the supporting base. The actuator comprises: a longitudinal body having a top end and a bottom end opposite each other, wherein the top end of the actuator includes the motor shaft that is adapted to engage or couple with the second end of the auger and the bottom end of the actuator is adapted to fit within the supporting base. The supporting base comprises: a longitudinal structure having a first end and a second end opposite each other, and one or more walls between the first end and the second end of the supporting base; wherein the first end of the supporting base includes a receptacle adapted to fit and receive the second end of the actuator; wherein the walls of the supporting base include one or more openings that provide access to the outlet.

Lastly, the outlet is integrated into the second end of the supporting base and comprises: a central opening that is adapted to receive and expel the filtered liquid within the receptacle of the supporting base; wherein the inlet is connected to the first end of the first hollow chamber; wherein the second end of the first hollow chamber is connected to the first end of the reactor; wherein the second end of the filter cup is connected to the first end of the reactor; and wherein the second end of the reactor is connected to the first end of the second hollow chamber.

### BRIEF DESCRIPTION OF THE DRAWINGS

FIG. 1 shows a perspective view of a mechanical sludge thickener system with a submersible actuator, in accordance with the principles of the present invention.

FIG. 2 shows an exploded view of the components of the mechanical sludge thickener system, in accordance with the principles of the present invention.

FIG. 3 shows a front view of the mechanical sludge thickener system, in accordance with the principles of the present invention.

FIG. 4 shows another exploded view of the components of the mechanical sludge thickener system, in accordance with the principles of the present invention.

FIG. 5 shows the flow of substances via the mechanical sludge thickener system, in accordance with the principles of the present invention.

FIG. 6 shows the flow of substances within the mechanical sludge thickener system, in accordance with the principles of the present invention.

FIG. 7 shows the filter cup and filter mesh components of the mechanical sludge thickener system, in accordance with the principles of the present invention.

FIG. 8 shows a close-up view of the actuator and auger components of the mechanical sludge thickener system, in accordance with the principles of the present invention.

FIG. 9 shows a close-up view of the auger component of the mechanical sludge thickener system, in accordance with the principles of the present invention.

FIG. 10 shows another close-up view of the auger component of the mechanical sludge thickener system, in accordance with the principles of the present invention.

FIG. 11 shows a close-up view of the actuator component of the mechanical sludge thickener system, in accordance with the principles of the present invention.

FIG. 12 shows a close-up view of the mechanical sludge thickener system, in accordance with the principles of the present invention.

FIG. 13 shows a side view of the reactor component of the mechanical sludge thickener system, in accordance with the principles of the present invention.

FIG. 14 shows a perspective view of the reactor component of the mechanical sludge thickener system, in accordance with the principles of the present invention.

FIG. 15 shows an exploded bottom perspective view of the mechanical sludge thickener system, in accordance with the principles of the present invention.

FIG. 16 shows the path of filtered liquid within the reactor component of the mechanical sludge thickener system, in accordance with the principles of the present invention.

FIG. 17 shows the path of semi-solid sludge within the reactor component of the mechanical sludge thickener system, in accordance with the principles of the present invention.

### DETAILED DESCRIPTION OF THE INVENTION

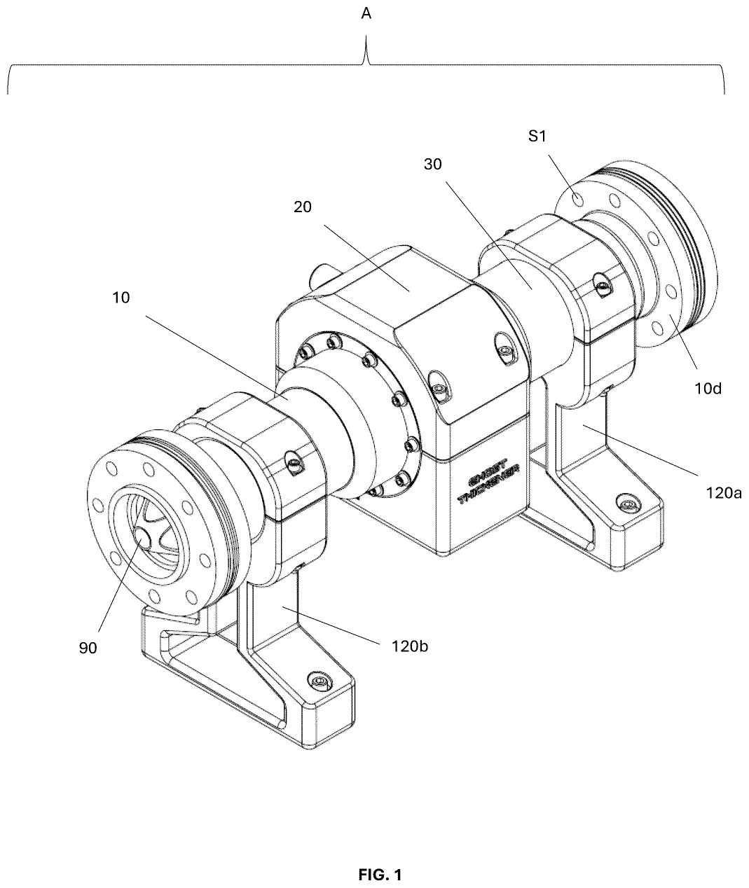

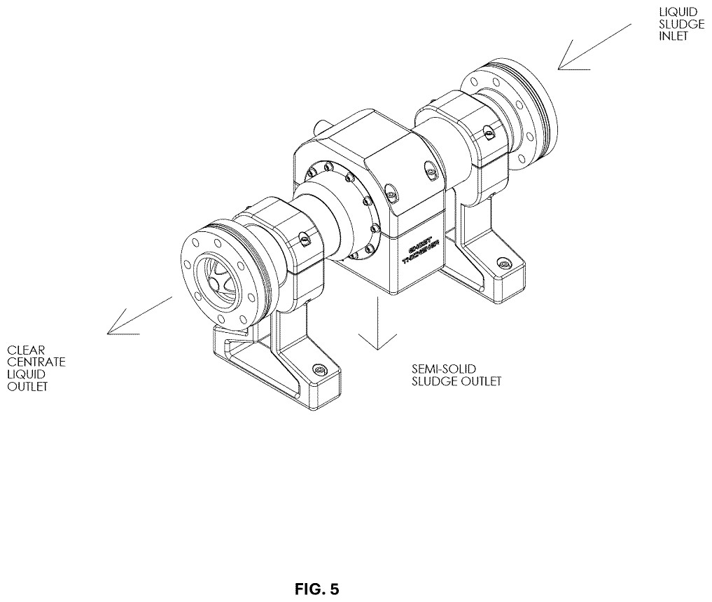

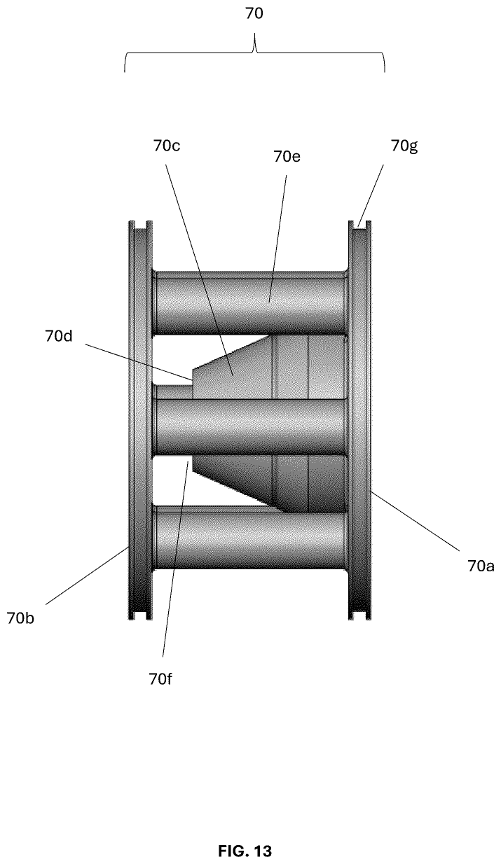

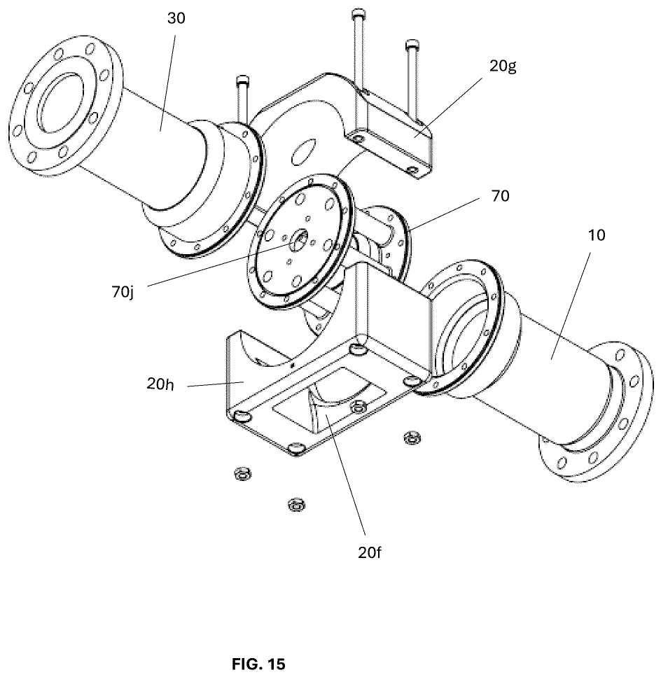

FIGS. 1-17 show a mechanical sludge thickener system A that comprises a first hollow chamber 10, an interconnecting chamber 20, a second hollow chamber 30, an actuator 40, a supporting base 41 for the actuator 40, an auger 50, a filter cup 60, a reactor 70, an inlet 80, and an outlet 90. As discussed below, the mechanical sludge thickener system A is designed to receive liquid sludge via the inlet 80 for subsequent transfer to the filter cup 60 inside the first hollow chamber 10 where the sludge is thickened by removing excess liquid in response to centripetal forces created by the auger 50. The thickened sludge is then discharged via the interconnecting chamber 20, while the remaining liquid is released through the outlet 90 in the second hollow chamber 30.

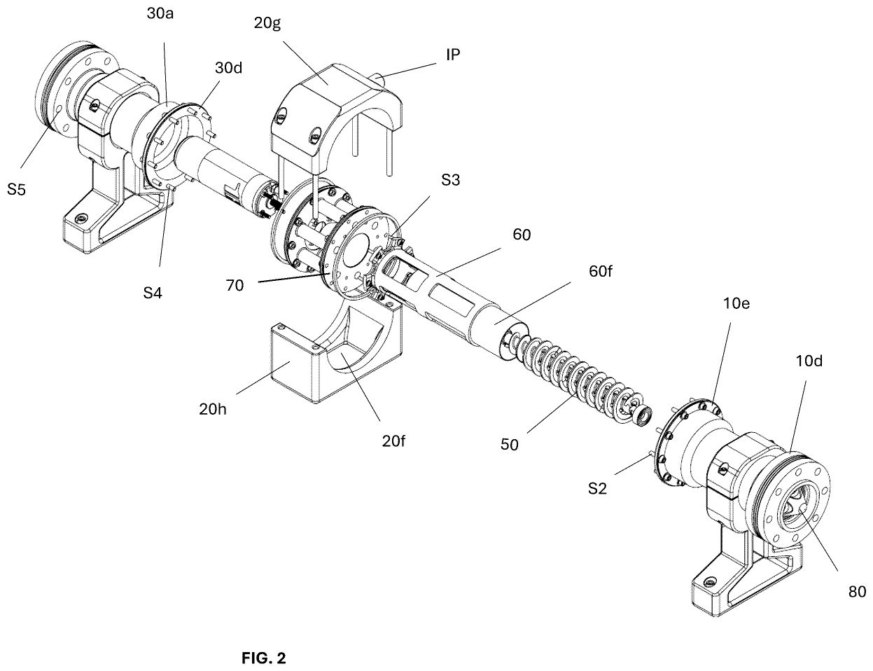

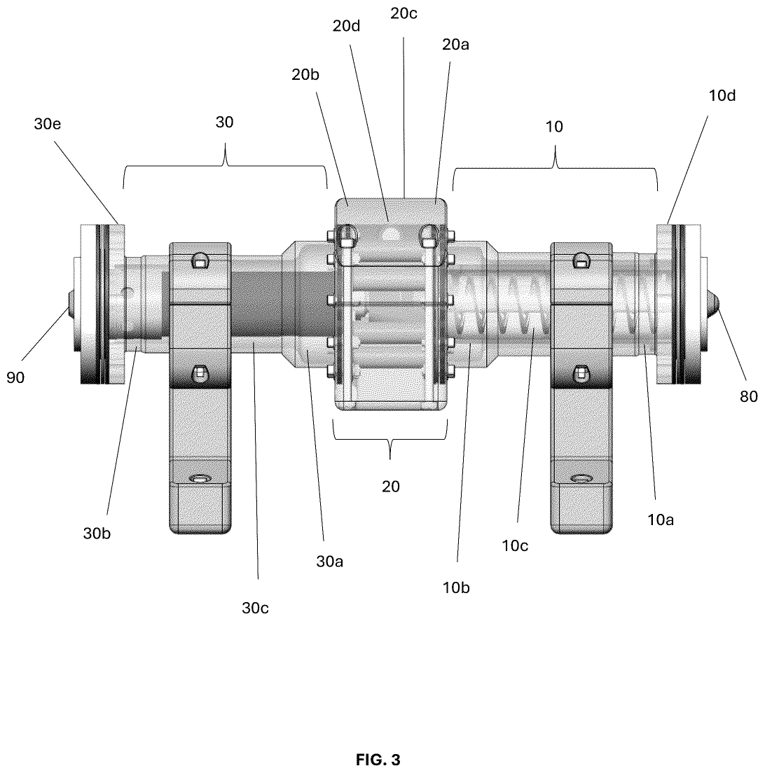

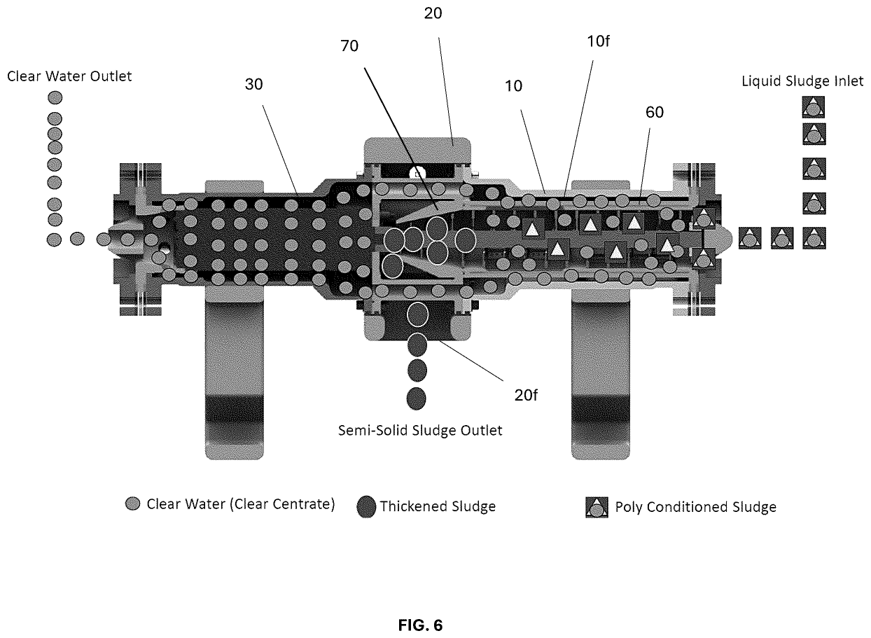

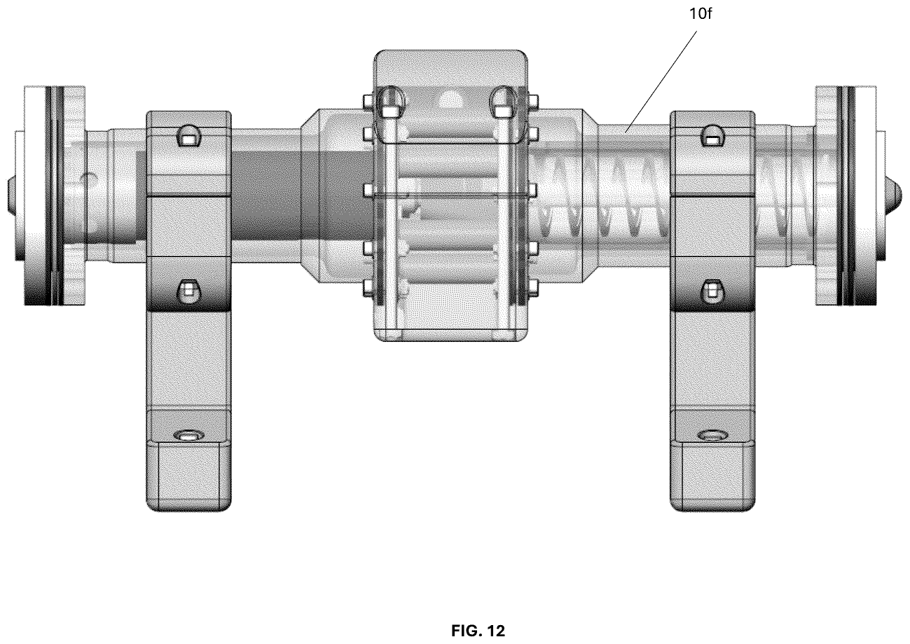

As shown in FIGS. 2-3, the first hollow chamber 10 comprises a hollow tube having a first end 10a and a second end 10b opposite each other, one or more walls 10c positioned between the first end 10a and the second end 10b of the first hollow chamber 10, and an interior space adapted to house and enclose the filter cup 60; wherein the first end 10a of the first hollow chamber 10 includes a flange 10d having one or more holes H1 adapted to receive one or more fasteners S1 for connection to the inlet 80; and wherein the second end 10b of the first hollow chamber 10 includes a flange 10e having one or more holes H2 adapted to receive one or more fasteners S2 for connection to the reactor 70. It should be noted that the placement of the filter cup 60 within the first hollow chamber 10 creates an annular space 10f between the filter cup 60 and the first hollow chamber 10, which serves as a passage for fluid flow, as shown in FIGS. 6 and 12. This annular space 10f is adapted to receive filtered liquid from the filter cup 60 and direct it towards the reactor 70, as further discussed below.

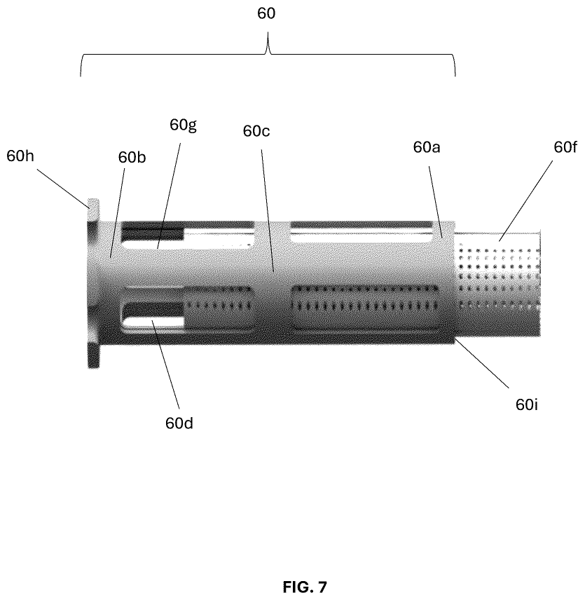

As show in FIG. 7, the filter cup 60 comprises a hollow longitudinal structure having a first end 60a and a second end 60b opposite each other, one or more walls 60c positioned between the first end 60a and the second 60b of the filter cup 60, an interior space 60d enclosed by the walls 60c of the filter cup 60, and a filter mesh 60f surrounding and conforming to the walls 60c within the interior space 60d of the filter cup 60. As such, the filter mesh 60f is located inside of the filter cup 60. The filter mesh 60f may comprise a perforated metal-type material or a mesh-type material. The filter mesh 60f includes a plurality of perforations configured to filter the liquid sludge within the filter cup 60.

Moreover, the filter cup 60 comprises one or more openings or windows 60g along the one or more walls 60c that, within the interior space 60d of the filter cup 60, are covered by the filter mesh 60f. It should be noted that the filter cup 60 is adapted to house the auger 50 within its interior space 60d.

The first end 60a of the filter cup 60 includes an opening 60i adapted to (i) provide the auger 50 with access to the anchor point 80c of the inlet 80; and (ii) provide the liquid sludge introduced via the inlet 80 with access to the auger 50 inside the filter cup 60. The second end 60b of the filter cup 60, on the other hand, is adapted to connect or interface with the reactor 70 via one or more bolts or fasteners S3. For example, the second end 60b of the filter cup 60 may include one or more projections 60h that include an opening adapted to receive the bolt or fastener S3 to secure the second end 60b of the filter cup 60 to the reactor 70.

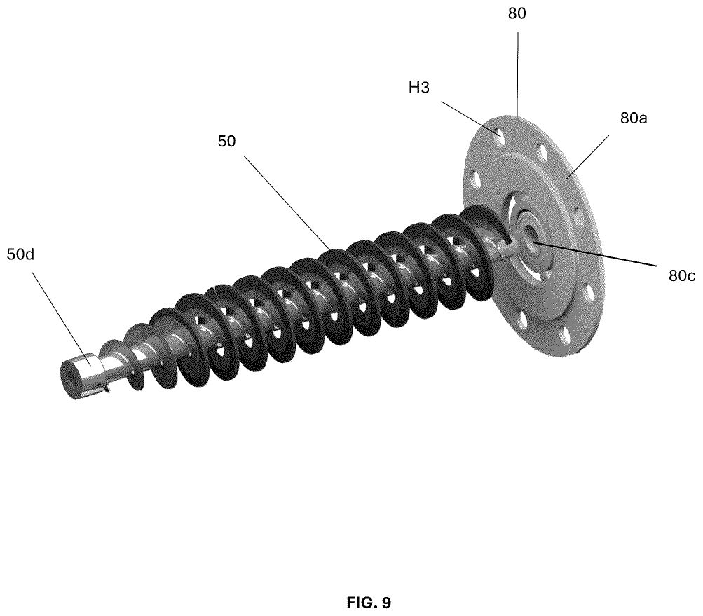

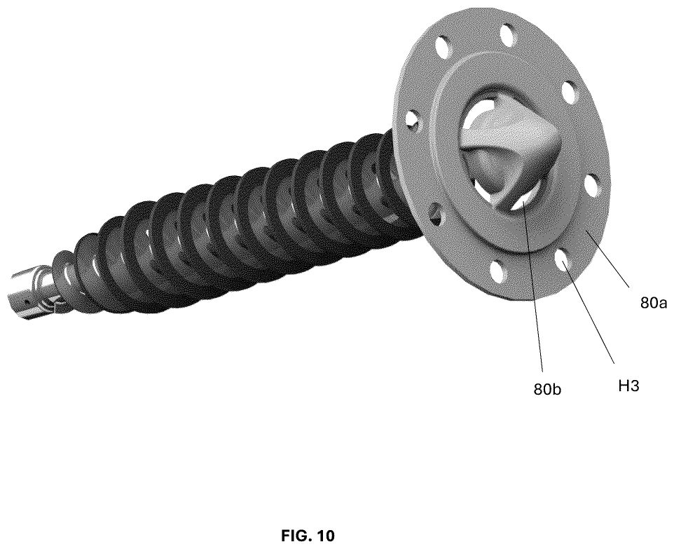

The inlet 80 may be integrated into the first end 10a of the first hollow chamber 10. Alternatively, as shown in FIGS. 9 and 10, the inlet 80 may be a separate piece that comprises a plate having a central anchor point 80c for the auger 50, an opening 80b adapted to receive liquid sludge; and a flange 80a with one or more holes H3 that are (i) aligned with the one or more holes H1 on the flange 10d on the first end 10a of the first hollow chamber 10; and (ii) adapted to receive the one or more fasteners S1. As such, the flange 10d of the first end 10a of the first hollow chamber 10, and the flange 80a of the inlet 80 are all secured to each other via the one or more fasteners S1. A rubber gasket may be positioned between flanges to avoid leakage of liquid. The central anchor point 80c may include one or more projections connected to the flange 80a of the inlet 80. The spaces between these projections create openings that allow the passage of liquid sludge, thereby functioning as the inlet 80 of the mechanical sludge thickener system A.

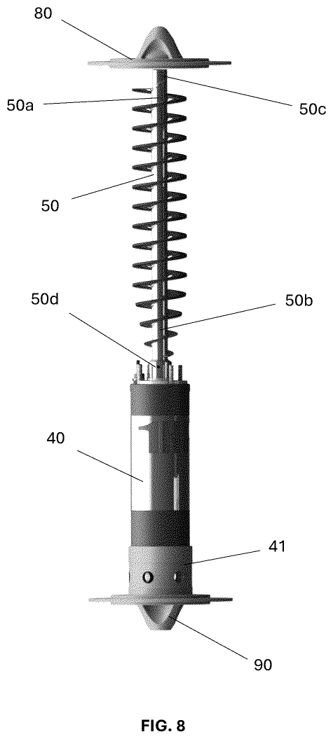

As shown in FIG. 8, the auger 50 comprises a helical screw having a first end 50a and a second end 50b opposite each other. The first end of the auger 50 includes a ball bearing 50c that is adapted to couple or interface with the anchor point 80c of the inlet 80. The second end 50b of the auger 50, on the other hand, includes a coupling unit 50d that is adapted to couple or interface with the motor shaft 40c of the actuator 40.

As shown in FIGS. 2-4, and 15, the interconnecting chamber 20 comprises a hollow casing having a first end 20a and a second end 20b opposite each other; one or more walls 20c positioned between the first end 20a and the second end 20b; an interior space 20d adapted to house and enclose the reactor 70; and a discharge outlet 20f on one of the walls 20c of the interconnecting chamber 20 for release of thickened sludge. The one or more walls 20c of the interconnecting chamber 20 also include an electrical interconnection port IP to provide the actuator 40 with access to a power source. As noted, the interconnecting chamber 20 encloses the reactor 70, which prevents thickened sludge from spilling through areas other than the discharge outlet 20f. It should be noted that the interconnecting chamber 20 may be subdivided into a removable top half 20g and a removable bottom half 20h, which connect to each other via one or more bolts, thereby fully enclosing the reactor 70, as shown in FIG. 2.

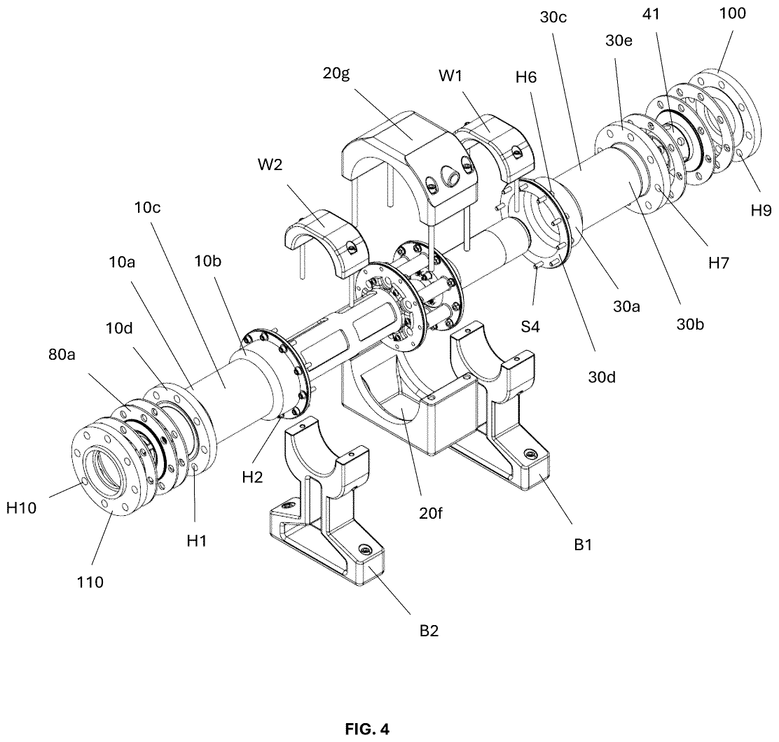

As shown in FIGS. 4, 13, and 14, the reactor 70, in turn, is located within the interior space 20d of the interconnecting chamber 20 and comprises (i) a first end 70a and a second end 70b opposite each other; (ii) a hollow conical cylinder 70c, located between the first end 70a and the second end 70b, that includes one or more tapered walls and a truncated vertex that forms a flat surface 70d; and (iii) one or more internal channels 70e connecting the first end 70a of the reactor to the second end 70b of the reactor 70, and surrounding the hollow conical cylinder 70c, wherein each of the internal channels 70e has an access point for receiving filtered liquid on the first end 70a of the reactor 70 and an exit point for releasing filtered liquid on the second end 70b of the reactor 70. It should be noted that each of the one or more internal channels 70e is adapted to receive, via the access point, the filtered liquid from the annular space 10f in the first hollow chamber 10 and transfer the filtered liquid, via the exit point, to the second hollow chamber 30.

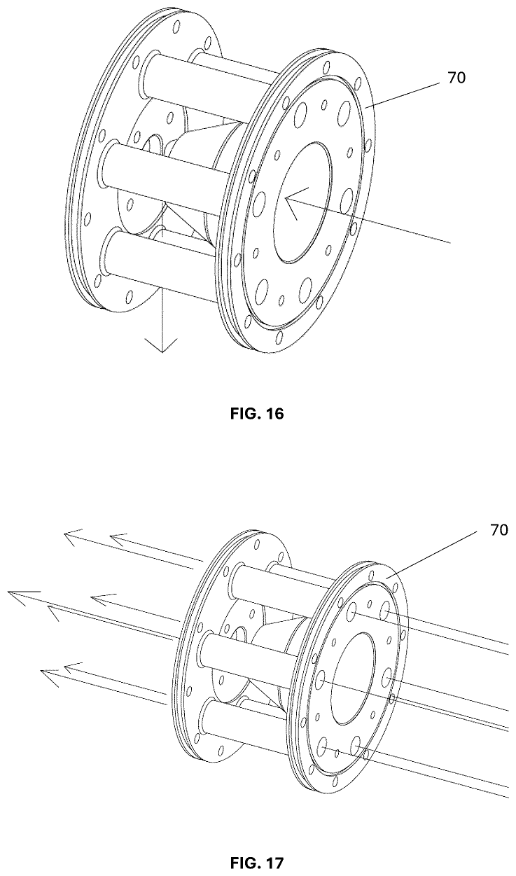

Moreover, the flat surface 70d of the hollow conical cylinder 70c includes an opening 70f adapted to (i) provide the coupling unit 50d on the second end of the auger 50 with access to the motor shaft 40c of the actuator 40; and (ii) provide the thickened sludge transported via the auger 50 with access to the discharge outlet 20f for removal from the mechanical sludge thickener system A. The tapered walls of the reactor 70 have a dual purpose: (1) to assist the auger 50 in guiding the thickened sludge towards the opening on the flat surface 70d of the reactor 70; and (2) avoid taking up unnecessary space between the first end 70a and second end 70b of the reactor 70 so that the thickened sludge can reach the discharge outlet 20f. FIG. 16 shows the path of semi-solid sludge as it enters the hollow conical cylinder 70c of the reactor 70 and exits through the opening 70f on the flat surface 70d of the cylinder, before being released via the discharge outlet 20f of the interconnecting chamber 20. FIG. 17 illustrates the path of filtered liquid as it flows from the annular space 10f in the first hollow chamber 10 into the internal channels 70e of the reactor 70, before being transferred to the second hollow chamber 30.

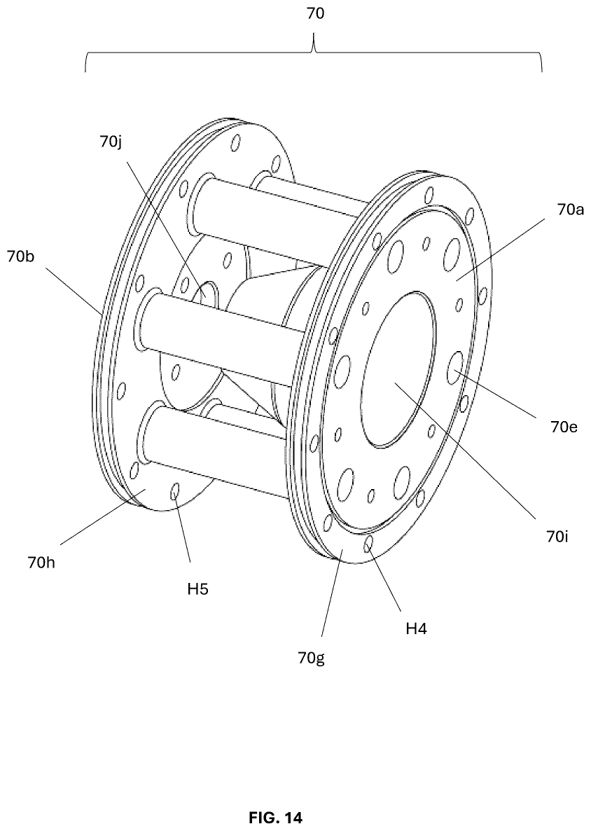

As shown in FIG. 14, the first end 70a of the reactor 70 includes a flange 70g having one or more holes H4 that (i) are aligned with the one or more holes H2 on the flange 10e at the second end of the first hollow chamber 10; and (ii) are adapted to receive the one or more fasteners S2, thereby securing the first end 70a of the reactor 70 to the second end 10b of the first hollow chamber 10. Conversely, the second end 70b of the reactor 70 includes a flange 70h having one or more holes H5 that are (i) are aligned with the one or more holes H6 on the flange 30d at the first end 30a of the second hollow chamber 30; and (ii) adapted to receive one or more fasteners S4, thereby securing the second end 70b of the reactor 70 to the first end 30a of the second hollow chamber 30. The first end 70a of the reactor 70 also includes a central opening 70i adapted to provide the coupling unit 50d on the second end 50b of the auger 50 with access to the interior of the hollow conical cylinder 70c of the reactor 70 for coupling with the motor shaft 40c of the actuator 40. Likewise, the second end 70b of the reactor 70 includes an opening 70j adapted to provide the motor shaft 40c the actuator 40 with access to the interior of the hollow conical cylinder 70c of the reactor 70 for coupling with the coupling unit 50d on the second end 50b of the auger 50.

As shown in FIG. 4, the second hollow chamber 30, in turn, comprises a hollow tube having a first end 30a and a second end 30b opposite each other, one or more walls 30c positioned between the first end 30a and the second end 30b of the second hollow chamber 30, and an interior space adapted to house or enclose the actuator 40; wherein the first end 30a of the second hollow chamber 30 includes a flange 30d having one or more holes H6 that (i) are aligned with the one or more holes H5 on the flange 70h at the second end 70b of the reactor 70; and (ii) are adapted to receive the one or more fasteners S4 for connection with the second end 70b of the reactor 70, thereby securing the first end 30a of the second hollow chamber 30 to the second end 70b of the reactor 70. Conversely, the second end 30b of the second hollow chamber 30 includes a flange 30e having one or more holes H7 adapted to receive one or more fasteners S5 for connection to the supporting base 41, as further discussed below.

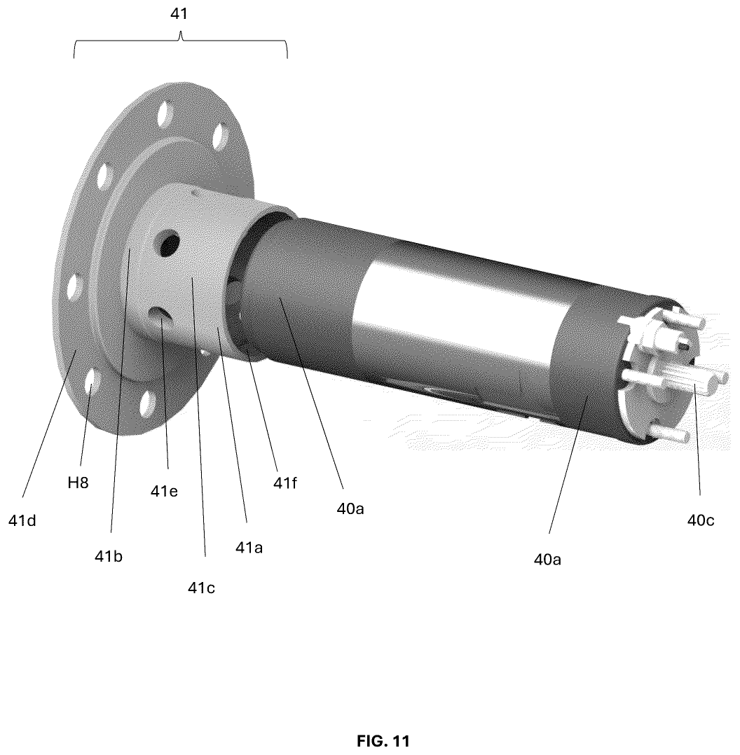

The actuator 40 is what drives the mechanical sludge thickener system A. As shown in FIG. 11, the actuator 40 is housed within the second hollow chamber 30 and comprises a longitudinal body having a top end 40a and a bottom end 40b opposite each other, wherein the top end 40a of the actuator 40 includes the motor shaft 40c that is adapted to engage or couple with the second end 50b of the auger 50, whereas the bottom end of the actuator 40 is adapted to fit within the supporting base 41 inside the second hollow chamber 30. Since the actuator 40 is located within the second hollow chamber 30, where the filtered liquid is transferred from the reactor 70, it must be a submersible actuator, such as a submersible electric motor, a submersible hydraulic motor, or a submersible pneumatic motor.

As shown in FIG. 11, the supporting base 41 for the actuator 40 is located within the second hollow chamber 30 and comprises a longitudinal structure having a first end 41a and a second end 41b opposite each other, and one or more walls 41c between the first end 41a and the second end 41b of the supporting base 41; wherein the first end 41a includes a hollow space or receptacle 41f adapted to fit the second end 40b of the actuator 40; and wherein the second end 41b includes a flange 41d having one or more holes H8 that are (i) aligned with the one or more holes H7 on the flange 30e at the second end 30a of the second hollow chamber 30; and (ii) adapted to receive the one or more fasteners S5, thereby securing the supporting base 41 to the second end 30b of the second hollow chamber 30. Moreover, the walls 41c of the supporting base 41 include one or more openings 41e that provide the filtered liquid within the second hollow chamber 30 with access to the outlet 90. As shown in FIG. 8, the outlet 90 is integrated into the second end 41b of the supporting base 41 and operates as a bottom end to the hollow space or receptacle 41f. The outlet 90 comprises a central opening 90b on the second end of the supporting base 41 that is adapted to (i) receive the filtered liquid within the hollow space or receptacle 41f; and (ii) to expel said filtered liquid from the mechanical sludge thickener system A. It should be noted that although the supporting base 41 is housed within the second hollow chamber 30, the outlet 90 (which is located on the second end of the supporting base 41) has access to the exterior of the second hollow chamber 30.

As shown in FIG. 4, a flange 100 may be attached to the second end 41b of the supporting base 41 to provide stability and protection to the outlet 90 and the second end of the 41b of the supporting base 41. The flange 100 surrounds the outlet 90 and includes one or more holes H9 that are (i) aligned with the one or more holes H7 on the flange 30e at the second end 30b of the second hollow chamber 30; (ii) aligned with the one or more holes H8 on the flange 41d at the second end 41b of the supporting base 41; and (iii) adapted to receive the one or more fasteners S5. This way, the flange 30e of the second end 30b of the second hollow chamber 30, the flange on 41d at the second end 41b of the supporting base 41, and the flange 100 can be secured to each other via the one or more fasteners S5. A rubber gasket may be positioned between the flanges to prevent liquid leakage. Likewise, a flange 110 may be attached to the first end 10a of the first hollow chamber 10 to provide stability and protection to the inlet 80 and the first end 10a of the first hollow chamber 10. The flange 110 surrounds the inlet 80 and includes one or more holes H10 that are (i) aligned with the one or more holes H1 on the flange 10d at the first end 10a of the first hollow chamber 10; (ii) aligned with the one or more holes H3 on the flange 80a of the inlet 80; and (iii) adapted to receive the one or more fasteners S1. A rubber gasket may be positioned between the flanges to prevent liquid leakage.

The mechanical sludge thickener system A may also comprise a first support platform 120a adapted to provide support to the first hollow chamber 10 and a second support platform 120b adapted to provide support to the second hollow chamber 30, as shown in FIG. 4. Each support platform comprises a base B1, B2 and one or more walls W1, W2 that perpendicularly extend from the corresponding base B1, B2 and surround, or are attached to, the corresponding first hollow chamber 10 or second hollow chamber 30.

In sum, when the sludge is introduced via the inlet 80, it is transferred to the filter cup 60 within the first hollow chamber 10. Once there, the rotation of the auger 50 generates centripetal forces that push the liquid particles in the sludge toward the filter mesh 60g, while the semi-solid particles are propelled by the auger 50 toward the reactor 70 within the interconnecting cup 20 for release via the discharge outlet 20f. Meanwhile, the liquid particles separated from the sludge pass through the filter mesh 60g and enter the annular space 10f inside the first hollow chamber 10. From there, the liquid particles are transferred to the internal channels 70e of the reactor 70 and ultimately into the second hollow chamber 30 for release via the outlet 90.

As such, the subject disclosure also relates to a method for thickening sludge using a mechanical sludge thickener system, the method comprising: (1) introducing liquid sludge via an inlet, wherein the inlet comprises a plate with a central anchor point for an auger, an opening for receiving liquid sludge, and a flange for connection to a first hollow chamber; (2) transferring the liquid sludge from the inlet into a filter cup housed within the first hollow chamber, wherein the first hollow chamber comprises a hollow tube with a first end and a second end, one or more walls positioned between the first and second ends, and an annular space located between the filter cup and the walls of the first hollow chamber; (3) filtering the liquid sludge by: rotating an auger positioned within the filter cup, wherein the auger comprises: a helical screw with a first and second end, a ball bearing at the first end coupled with the anchor point of the inlet, a coupling unit at the second end;

and forcing liquid through a filter mesh that conforms to the walls of the filter cup, thereby separating liquid from the sludge and producing a filtered liquid, which passes into the annular space, and a thickened sludge, which moves toward an interconnecting chamber; (4) transporting the thickened sludge into a reactor housed within the interconnecting chamber, wherein the interconnecting chamber comprises a hollow casing with a first and second end, one or more walls enclosing the reactor, and a discharge outlet for releasing thickened sludge; (5) processing the thickened sludge within the reactor, wherein the reactor comprises a hollow conical cylinder with a first and second end, one or more tapered walls and a truncated vertex forming a flat surface, and one or more internal channels surrounding the conical cylinder, wherein: the internal channels receive filtered liquid from the annular space via access points at the first end of the reactor; and the internal channels transfer the filtered liquid to a second hollow chamber via exit points at the second end of the reactor; (6) releasing the thickened sludge through an opening on the flat surface of the reactor, directing it to the discharge outlet of the interconnecting chamber; (7) transferring the filtered liquid into the second hollow chamber, wherein the second hollow chamber comprises a hollow tube with a first and second end, and an interior space adapted to house an actuator and a supporting base; (8) driving the auger using the actuator, wherein the actuator comprises a longitudinal body with a top end and a bottom end, a motor shaft at the top end that couples with the second end of the auger, and a bottom end fitted within a supporting base; and (9) expelling the filtered liquid from the second hollow chamber through an outlet, wherein the supporting base includes a receptacle adapted to receive filtered liquid, one or more openings in the walls of the supporting base provide access to the outlet, wherein the outlet, positioned at the second end of the supporting base, comprises a central opening for expelling the filtered liquid.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

What is claimed is:

1. A mechanical sludge thickener system, comprising:
a first hollow chamber, an interconnecting chamber, a second hollow chamber, an actuator, a supporting base, an auger, a filter cup, a reactor, an inlet, and an outlet;
wherein the inlet comprises:
a plate having a central anchor point for the auger, an opening for receiving liquid sludge, and a flange;
wherein the first hollow chamber comprises:
a first hollow tube having a first end and a second end opposite each other, one or more walls positioned between the first end and the second end of the first hollow chamber, and an interior space adapted to house and enclose the filter cup; and an annular space within the first hollow tube, located between the filter cup and the one or more walls of the first hollow chamber;
wherein the filter cup comprises:
a hollow longitudinal structure having a first end and a second end opposite each other, one or more walls positioned between the first end and the second of the filter cup, an interior space enclosed by the walls of the filter cup, and a filter mesh surrounding and conforming to the one or more walls within the interior space of the filter cup; and
one or more openings along the one or more walls of the filter cup that, within the interior space of the filter cup, are covered by the filter mesh;
wherein the filter mesh is configured to separate liquid from the liquid sludge, producing a filtered liquid and a thickened sludge;
wherein the auger comprises:
a helical screw having a first end and a second end opposite each other;
wherein the first end of the auger includes a ball bearing that is adapted to couple with the anchor point of the inlet; and
wherein the second end of the auger includes a coupling unit;
wherein the interconnecting chamber comprises:
a hollow casing having a first end and a second end opposite each other, one or more walls positioned between the first end and the second end, an interior space adapted to house and enclose the reactor, and a discharge outlet on one of the walls of the interconnecting chamber for release of the thickened sludge;
wherein the reactor comprises:
a first end and a second end opposite each other;
a hollow conical cylinder, located between the first end and the second end, that includes one or more tapered walls and a truncated vertex that forms a flat surface;
one or more internal channels connecting the first end of the reactor to the second end of the reactor, and surrounding the hollow conical cylinder;
wherein each of the internal channels has an access point on the first end of the reactor and an exit point on the second end of the reactor;
wherein each of the one or more internal channels is adapted to receive the filtered liquid, via the access point, from the annular space in the first hollow chamber and transfer the filtered liquid, via the exit point, to the second hollow chamber;
wherein the flat surface includes an opening that provides access to the discharge outlet;
wherein the first end of the reactor includes a central opening adapted to provide access to the interior of the hollow conical cylinder of the reactor;
wherein the second end of the reactor includes an opening adapted to provide access to the interior of the hollow conical cylinder of the reactor;
wherein the second hollow chamber comprises:
a second hollow tube having a first end and a second end opposite each other, one or more walls positioned between the first end and the second end of the second hollow chamber, and an interior space adapted to house the actuator and the supporting base;
wherein the actuator comprises:
a longitudinal body having a top end and a bottom end opposite each other, wherein the top end of the actuator includes the motor shaft that is adapted to engage or couple with the second end of the auger and the bottom end of the actuator is adapted to fit within the supporting base;
wherein the supporting base comprises:
a longitudinal structure having a first end and a second end opposite each other, and one or more walls between the first end and the second end of the supporting base;
wherein the first end of the supporting base includes a receptacle adapted to fit and receive the second end of the actuator;
wherein the walls of the supporting base include one or more openings that provide access to the outlet;
wherein the outlet is integrated into the second end of the supporting base and comprises:
a central opening that is adapted to receive and expel the filtered liquid within the receptacle of the supporting base;
wherein the inlet is connected to the first end of the first hollow chamber;
wherein the second end of the first hollow chamber is connected to the first end of the reactor;
wherein the second end of the filter cup is connected to the first end of the reactor; and
wherein the second end of the reactor is connected to the first end of the second hollow chamber.

2. The mechanical sludge thickener system of claim 1, wherein the first end of the filter cup includes an opening adapted to provide the auger with access to the anchor point of the inlet.

3. The mechanical sludge thickener system of claim 1, wherein the central anchor point of the inlet includes one or more projections connected to the flange of the inlet.

4. The mechanical sludge thickener system of claim 1, wherein the coupling unit of the auger is adapted to couple or interface with the motor shaft of the actuator.

5. The mechanical sludge thickener system of claim 1, wherein the interconnecting chamber is subdivided into a removable top half and a removable bottom half connected to each other via one or more bolts.

6. The mechanical sludge thickener system of claim 1, wherein the actuator is a submersible electric motor, or a submersible hydraulic motor, or a submersible pneumatic motor.

7. The mechanical sludge thickener system of claim 1, wherein the first end of the first hollow chamber comprises a flange.

8. The mechanical sludge thickener system of claim 7, further comprising a flange connected to the flange on the first end of the first hollow chamber.

9. The mechanical sludge thickener system of claim 1, wherein the second end of the second hollow chamber comprises a flange.

10. The mechanical sludge thickener system of claim 9, further comprising a flange connected to the flange on the second end of the second hollow chamber.

11. The mechanical sludge thickener system of claim 1, further comprising a first support platform for providing support to the first hollow chamber.

12. The mechanical sludge thickener system of claim 11, further comprising a second support platform for providing support to the second hollow chamber.

13. The mechanical sludge thickener system of claim 12, wherein each of the first support platform and the second support platform comprises a base and one or more walls that perpendicularly extend from the corresponding base, and wherein the one or more walls on each base are attached to the corresponding first hollow chamber or second hollow chamber.

14. A method for thickening sludge using a mechanical sludge thickener system, the method comprising:
introducing liquid sludge via an inlet, wherein the inlet comprises a plate with a central anchor point for an auger, an opening for receiving liquid sludge, and a flange for connection to a first hollow chamber;
transferring the liquid sludge from the inlet into a filter cup housed within the first hollow chamber, wherein the first hollow chamber comprises a hollow tube with a first end and a second end, one or more walls positioned between the first and second ends, and an annular space located between the filter cup and the walls of the first hollow chamber;
filtering the liquid sludge by:
rotating an auger positioned within the filter cup, wherein the auger comprises: a helical screw with a first and second end, a ball bearing at the first end coupled with the anchor point of the inlet, a coupling unit at the second end; and
forcing liquid through a filter mesh that conforms to the walls of the filter cup, thereby separating liquid from the sludge and producing a filtered liquid, which passes into the annular space, and a thickened sludge, which moves toward an interconnecting chamber;
transporting the thickened sludge into a reactor housed within the interconnecting chamber, wherein the interconnecting chamber comprises a hollow casing with a first and second end, one or more walls enclosing the reactor, and a discharge outlet for releasing thickened sludge;
processing the thickened sludge within the reactor, wherein the reactor comprises a hollow conical cylinder with a first and second end, one or more tapered walls and a truncated vertex forming a flat surface, and one or more internal channels surrounding the conical cylinder, wherein:
the internal channels receive filtered liquid from the annular space via access points at the first end of the reactor; and
the internal channels transfer the filtered liquid to a second hollow chamber via exit points at the second end of the reactor;
releasing the thickened sludge through an opening on the flat surface of the reactor, directing it to the discharge outlet of the interconnecting chamber;
transferring the filtered liquid into the second hollow chamber, wherein the second hollow chamber comprises a hollow tube with a first and second end, and an interior space adapted to house an actuator and a supporting base;
driving the auger using the actuator, wherein the actuator comprises a longitudinal body with a top end and a bottom end, a motor shaft at the top end that couples with the second end of the auger, and a bottom end fitted within a supporting base; and
expelling the filtered liquid from the second hollow chamber through an outlet, wherein the supporting base includes a receptacle adapted to receive filtered liquid, one or more openings in the walls of the supporting base provide access to the outlet, wherein the outlet, positioned at the second end of the supporting base, comprises a central opening for expelling the filtered liquid.
